(19) United States
(12) Patent Application Publication
(10) Pub. No.: US 2024/0317115 A1
(43) Pub. Date: Sep. 26, 2024

(54) SEAT INSTALLATION STRUCTURE

(71) Applicant: Honda Motor Co., Ltd., Tokyo (JP)

(72) Inventor: Taiki TERUI, Tokyo (JP)

(73) Assignee: Honda Motor Co., Ltd., Tokyo (JP)

(21) Appl. No.: 18/583,753

(22) Filed: Feb. 21, 2024

(30) Foreign Application Priority Data
Mar. 21, 2023 (CN) 202310278849.4

(51) Int. Cl. B60N 2/005; B62D 21/03; B62D 25/20

(52) U.S. Cl. CPC B60N 2/005; B62D 21/03; B62D 25/20

(57) ABSTRACT

A seat installation structure includes: a floor; a floor cross beam, connected to lower longitudinal beams on outer sides in a vehicle-width-direction; and a seat fixing portion, configured to fix a back seat. The seat fixing portion includes: a fixed seat surface, configured to fix the back seat formed on the floor behind the floor cross beam; and a reinforcing member, forming a hollow portion with the fixed seat surface on an outside of the fixed seat surface, and the reinforcing member is connected to the floor cross beam.

### CROSS-REFERENCE TO RELATED APPLICATION

This application claims the priority benefit of China application serial no. 202310278849.4, filed on Mar. 21, 2023. The entirety of the above-mentioned patent application is hereby incorporated by reference herein and made a part of this specification.

### BACKGROUND

### Technical Field

The disclosure relates to a seat installation structure.

### Description of Related Art

In recent years, efforts to provide access to sustainable transportation systems that also take into account vulnerable persons such as the elderly, and children among traffic participants have been active. In order to achieve the stated purpose, research and development efforts are made to further improve the safety and convenience of transportation through development related to improving the rigidity of the vehicle body. Various solutions have been proposed in the past regarding the seat installation structure for automotive that securely installs the seat to the vehicle body.

For example, in Patent Document 1 (Japanese Patent Application Laid-Open No. 2006-335287), the cross-section of the vehicle frame has a seat installing bracket, and the seat is installed on the seat installing bracket of the vehicle frame to ensure the installing rigidity of the seat. However, when a vehicle frame is provided with a seat installing bracket, the size of the vehicle frame is also increased due to the need to add reinforcing members to the vehicle frame or to ensure clearance with components such as the seat installing bracket. In addition, in Patent Document 1, when the seat is directly fixed to the beam, it is necessary to drill holes in the beam. In this way, the support surface needs to be enlarged, and reinforcing members need to be added to compensate for the decrease in rigidity caused by the hole, which leads to a larger and heavier beam. However, taking into account the need for miniaturization and lightweighting may result in compromised rigidity of the seat installing and submarine effect.

### SUMMARY

The disclosure provides a seat installation structure, which is capable of suppressing the increase in structure size while ensuring seat installation rigidity.

The disclosure provides a seat installation structure including: a floor; a floor cross beam, connected to lower longitudinal beams on outer sides in a vehicle-width-direction; and a seat fixing portion, configured to fix a back seat. The seat fixing portion includes: a fixed seat surface, configured to fix the back seat formed on the floor behind the floor cross beam; and a reinforcing member, forming a hollow portion with the fixed seat surface on an outside of the fixed seat surface, and the reinforcing member is connected to the floor cross beam.

Based on the above, by providing the reinforcing member behind the floor cross beam and connected to the floor cross beam in the seat installation structure, in the event of a front-side collision, the load input from the back seat may be efficiently transferred to the floor cross beam through the reinforcing member. In this way, the deformation of the seat fixing portion may be suppressed, thereby suppressing the sinking of the front of the back seat, that is, the so-called submarine effect. In addition, by providing the reinforcing member for supporting the back seat behind the floor cross beam provided under the back seat, the number of reinforcing members and fixing holes for installing the floor cross beam to the seat is reduced, thereby suppressing an increase in the size of the floor cross beam.

In order to make the above-mentioned features and advantages of the disclosure comprehensible, embodiments accompanied with drawings are described in detail below.

### BRIEF DESCRIPTION OF THE DRAWINGS

FIG. 1 is a three-dimensional schematic view of the seat installation structure according to one embodiment of the disclosure.

FIG. 2 is an enlarged schematic view of the seat fixing portion in FIG. 1.

FIG. 3 is a schematic top view of the seat installation structure in FIG. 1.

FIG. 4 is a cross-sectional schematic side view of the seat installation structure in FIG. 1 taken along the line A-A in FIG. 3.

FIG. 5 is a cross-sectional schematic view of the seat installation structure in FIG. 1 taken along the line A-A in FIG. 3 from the viewing angle of FIG. 1.

FIG. 6 is a three-dimensional schematic view of the seat installation structure in FIG. 1 with the rear panel portion removed.

FIG. 7 is an enlarged schematic view of the reinforcing member in FIG. 6.

### DESCRIPTION OF THE EMBODIMENTS

In one embodiment of the disclosure, the floor cross beam is provided between a front panel portion and a rear panel portion of the floor, where the rear panel portion is formed above the front panel portion, the floor cross beam has a stepped portion between the front panel portion and the rear panel portion, and the reinforcing member is provided above the stepped portion.

In one embodiment of the disclosure, the stepped portion is entirely bent upward while extending from two ends toward a center.

In one embodiment of the disclosure, the floor cross beam includes an upper portion member and a lower portion member, and the upper portion member and the lower portion member form a closed cross-section. The upper portion member includes a front wall forming a front portion of the closed cross-section and an upper wall forming an upper portion of the closed cross-section. The lower portion member includes a rear wall forming a rear portion of the closed cross-section, a lower wall forming a lower side of the closed cross-section, and a rear wall extending portion extending upward from the rear wall to the rear portion of the closed cross-section. The reinforcing member is connected to the rear wall extending portion.

In one embodiment of the disclosure, the reinforcing member includes a flange, which is connected to the rear wall extending portion of the lower portion member, and the flange extends downward and includes a protruded rib portion extending downward.

In one embodiment of the disclosure, an end portion of an upper edge of the rear wall extending portion on an outer side in the vehicle-width-direction is provided with a bending portion extending toward the lower longitudinal beams and bent downward, and the reinforcing member is provided on an inner side of the bending portion in the vehicle-width-direction.

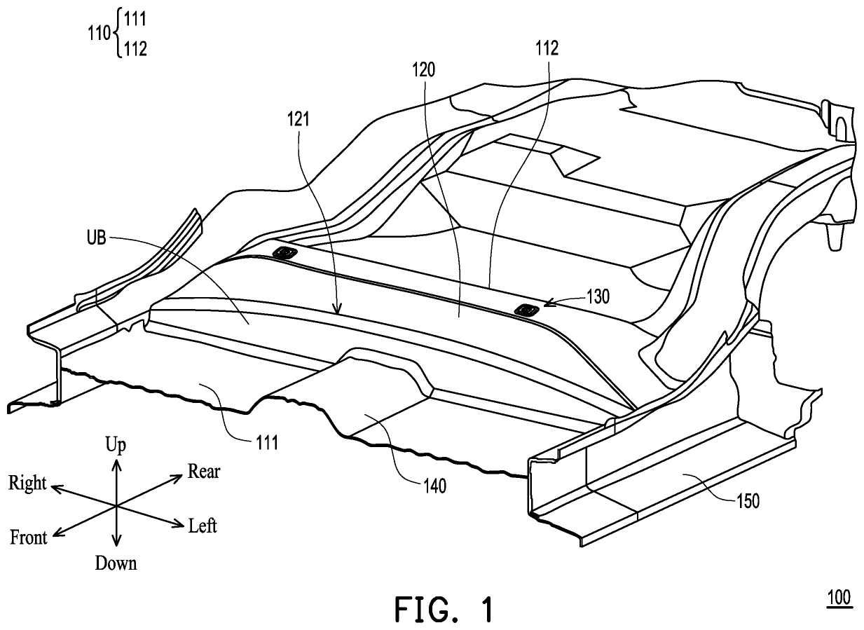

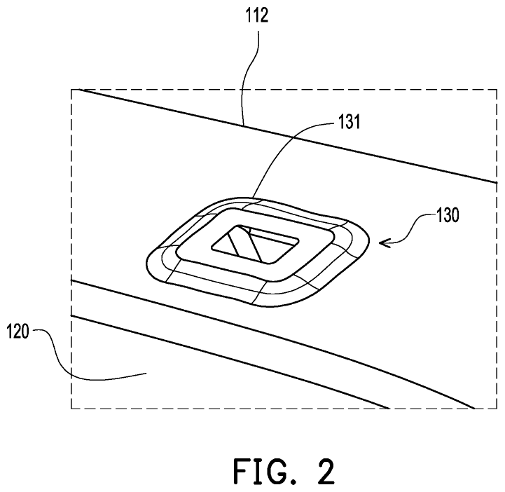

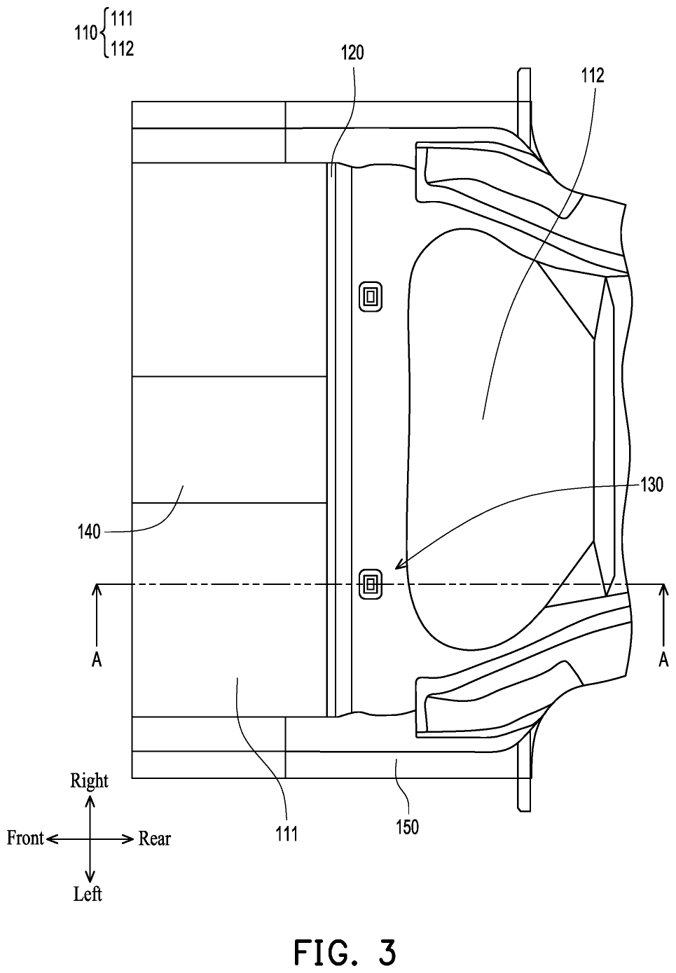

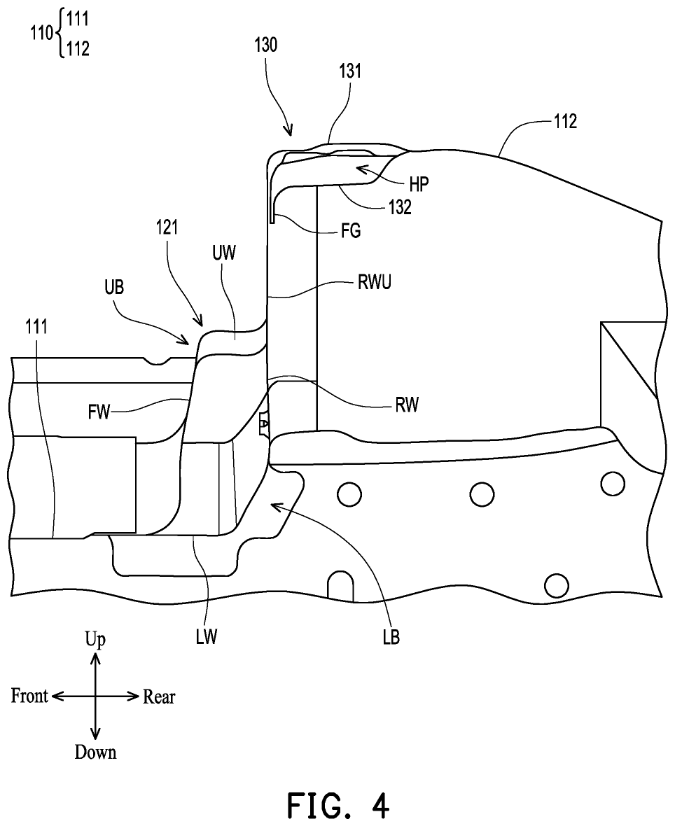

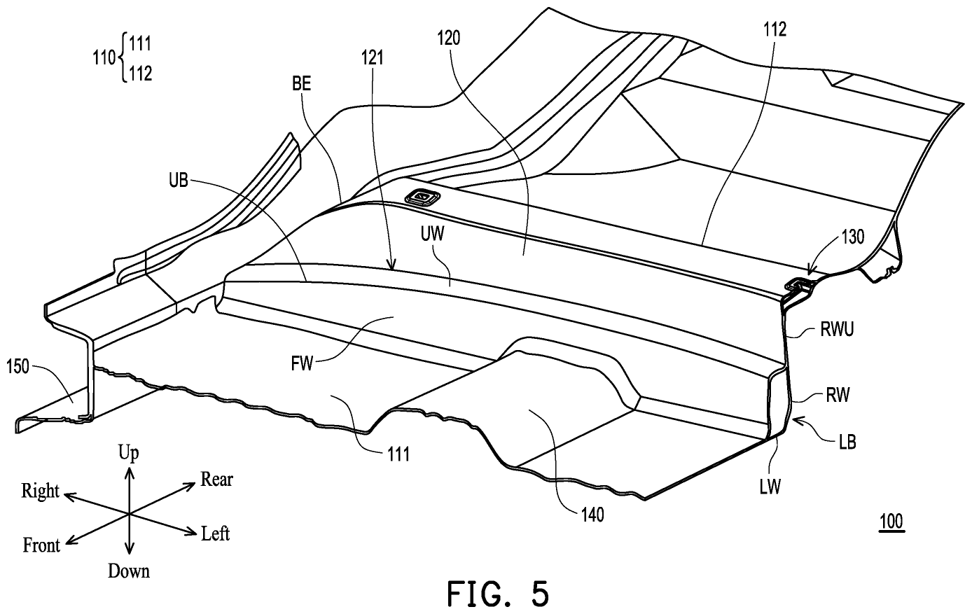

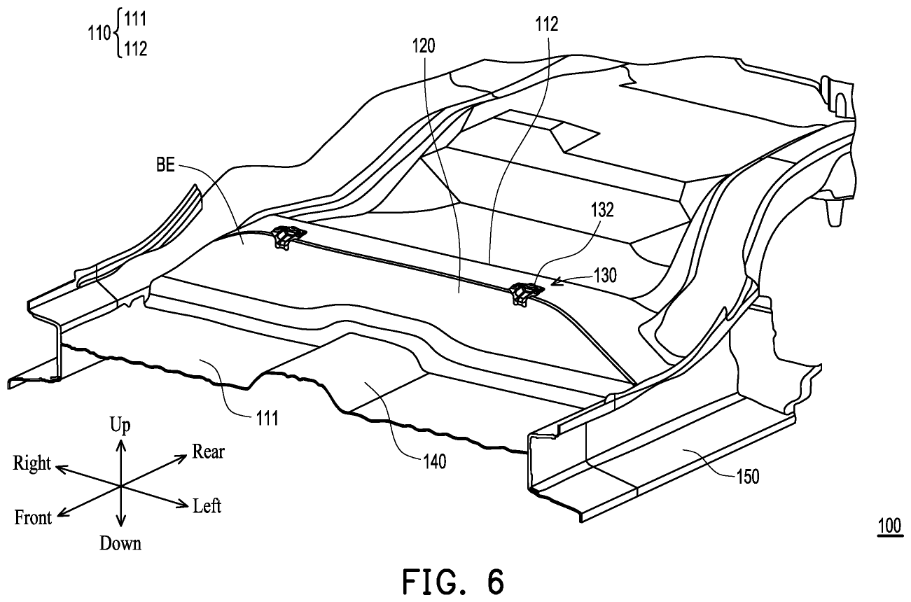

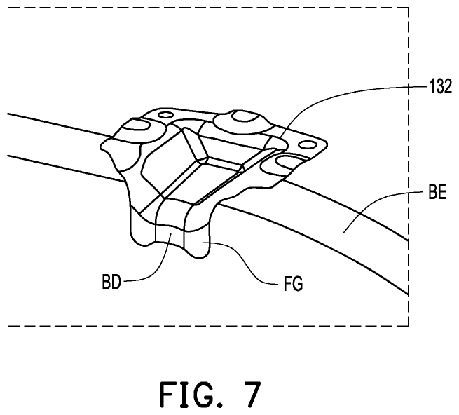

FIG. 1 is a three-dimensional schematic view of the seat installation structure according to one embodiment of the disclosure. FIG. 2 is an enlarged schematic view of the seat fixing portion in FIG. 1. FIG. 3 is a schematic top view of the seat installation structure in FIG. 1. FIG. 4 is a cross-sectional schematic side view of the seat installation structure in FIG. 1 taken along the line A-A in FIG. 3. FIG. 5 is a cross-sectional schematic view of the seat installation structure in FIG. 1 taken along the line A-A in FIG. 3 from the viewing angle of FIG. 1. FIG. 6 is a three-dimensional schematic view of the seat installation structure in FIG. 1 with the rear panel portion removed. FIG. 7 is an enlarged schematic view of the reinforcing member in FIG. 6. It should be noted that, for convenience, the front and rear direction, the left and right direction, and the up and down direction of a vehicle are defined as shown in the figures, and the composition of each portion is described according to this definition. The front and rear direction, the left and right direction, and the up and down direction are equivalent to the vehicle-length-direction, the vehicle-width-direction, and the vehicle-height-direction, respectively.

Specifically, in this embodiment, the vehicle body of the vehicle is made of high-strength metal plates such as steel plates and aluminum alloy plates, and a seat (not shown) is provided on the floor surface of the vehicle interior formed by the vehicle body. A seat installation structure 100 is provided between the seat and the floor. Moreover, in this embodiment, the seat installation structure 100 refers to the structure provided behind the vehicle for fixing the back seat on the floor 110.

Referring to FIG. 1 to FIG. 7, the seat installation structure 100 includes a floor 110, a floor tunnel 140, a floor cross beam 120, a pair of left and right lower longitudinal beams 150, and a seat fixing portion 130. The floor 110 includes relatively thin metal plates such as steel plates and aluminum alloy plates, and is provided between the lower longitudinal beams 150 and the floor tunnel 140 and behind the floor cross beam 120. The floor tunnel 140 is extended along the vehicle-length-direction at the center portion of the floor 110, and the vehicle body is formed into a substantially left-right symmetrical shape with the floor tunnel 140 as the center. The floor tunnel 140 not only forms a configuration space for a structure extending along the vehicle-length-direction like a fuel pipe and an exhaust pipe, but also contributes to improving the rigidity of the floor 110. The floor cross beam 120 is provided along the vehicle-width-direction and is orthogonal to the floor tunnel 140, and is connected to the lower longitudinal beams 150 on the outer sides in the vehicle-width-direction. The lower longitudinal beams 150 are connected to two end portions of the floor cross beam 120 and extends along the vehicle-length-direction. The seat fixing portion 130 is configured to fix the back seat.

Furthermore, as shown in FIG. 2 to FIG. 4, the seat fixing portion 130 includes a fixed seat surface 131 and a reinforcing member 132. In this embodiment, the reinforcing member 132 is, for example, a gusset. The fixed seat surface 131 is configured to fix the back seat formed on the floor 110 behind the floor cross beam 120. The reinforcing member 132 forms a hollow portion HP with the fixed seat surface 131 on an outside of the fixed seat surface 131, and the reinforcing member 132 is connected to the floor cross beam 120.

In this way, through the configuration of the reinforcing member 132 provided behind the floor cross beam 120 and connected to the floor cross beam 120, in the event of a front-side collision, the load input from the back seat may be efficiently transferred to the floor cross beam 120 through the reinforcing member 132. As a result, the deformation of the seat fixing portion 130 may be suppressed, thereby suppressing the sinking of the front of the back seat and suppressing the occurrence of the so-called submarine effect in which an occupant bound to a vehicle seat by a seat belt device becomes trapped in the seat cushion during a front-side collision of the vehicle. In addition, by providing the reinforcing member 132 for supporting the back seat behind the floor cross beam 120 provided under the back seat, the number of reinforcing members and fixing holes for installing the floor cross beam 120 to the seat is reduced, thereby suppressing an increase in the size of the floor cross beam 120.

As shown in FIG. 2 to FIG. 4, in this embodiment, the floor cross beam 120 is provided between a front panel portion 111 and a rear panel portion 112 of the floor 110, where the rear panel portion 112 is formed above the front panel portion 111. The floor cross beam 120 has a stepped portion 121 between the front panel portion 111 and the rear panel portion 112. The reinforcing member 132 is provided above the stepped portion 121. Furthermore, as shown in FIG. 2 to FIG. 4, the stepped portion 121 is entirely bent upward while extending from two ends toward the center.

In this way, by providing the stepped portion 121 on the floor cross beam 120 in front of the reinforcing member 132 of the seat fixing portion 130, the load input from the back seat in the event of a front-side collision may be efficiently transferred to the floor cross beam 120 though the reinforcing member 132, and deformation of the seat fixing portion 130 may be further suppressed. In addition, by entirely bending the stepped portion 121 upward while extending from two ends toward the center, the load applied from the upper direction to the lower direction of the floor cross beam 120 may be efficiently transferred to the floor 110 and the lower longitudinal beams 150, which may improve the rigidity of the floor cross beam 120, thereby suppressing the deformation of the seat fixing portion 130.

Furthermore, as shown in FIG. 4 and FIG. 5, in this embodiment, the floor cross beam 120 includes an upper portion member UB and a lower portion member LB, and the upper portion member UB and the lower portion member LB form a closed cross-section. More specifically, the upper portion member UB includes a front wall FW forming a front portion of the closed cross-section and an upper wall UW forming an upper portion of the closed cross-section. The lower portion member LB includes a rear wall RW forming a rear portion of the closed cross-section, a lower wall LW forming a lower side of the closed cross-section, and a rear wall extending portion RWU extending upward from the rear wall RW to the rear portion of the closed cross-section. Moreover, in this embodiment, the reinforcing member 132 is connected to the rear wall extending portion RWU.

In this way, through connecting the reinforcing member 132 forming the seat fixing portion 130 to the rear wall extending portion RWU of the lower portion member LB of the floor cross beam 120, the load input from the back seat may be efficiently transferred to the floor cross beam 120 and the floor 110. Thus, deformation of the seat fixing portion 130 in the event of a front-side collision may be suppressed.

In addition, as shown in FIG. 4, FIG. 6, and FIG. 7, in this embodiment, the reinforcing member 132 includes a flange FG, which is connected to the rear wall extending portion RWU of the lower portion member LB, and the flange FG extends downward and includes a protruded rib portion BD extending downward. In this embodiment, the protruded rib portion BD is formed, for example, by a weld bead. Since the flange FG connected to the rear wall extending portion RWU of the reinforcing member 132 has the protruded rib portion BD extending downward, the load input from the back seat may be efficiently transferred to the floor cross beam 120, thereby suppressing the deformation of the seat fixing portion 130 in the event of a front-side collision.

On the other hand, as shown in FIG. 6, in this embodiment, the floor cross beam 120 is provided with a bending portion BE extending toward the lower longitudinal beams 150 and bent downward provided at an end portion of an upper edge of the rear wall extending portion RWU on an outer side in the vehicle-width-direction, and the reinforcing member 132 is provided on an inner side of the bending portion BE in the vehicle-width-direction. In this way, by providing the reinforcing member 132 on the inner side of the bending portion BE in the vehicle-width-direction, the load input from the back seat to the reinforcing member 132 may be transferred to the lower longitudinal beams 150 through the bending portion BE. Thus, deformation of the seat fixing portion 130 in the event of a front-side collision may be suppressed.

To sum up, in the embodiment of the disclosure, by providing the reinforcing member behind the floor cross beam and connected to the floor cross beam in the seat installation structure, in the event of a front-side collision, the load input from the back seat may be efficiently transferred to the floor cross beam through the reinforcing member. In this way, the deformation of the seat fixing portion may be suppressed, thereby suppressing the sinking of the front of the back seat, that is, the so-called submarine effect. In addition, by providing the reinforcing member for supporting the back seat behind the floor cross beam provided under the back seat, the number of reinforcing members and fixing holes for installing the floor cross beam to the seat is reduced, thereby suppressing an increase in the size of the floor cross beam.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A seat installation structure, comprising:
a floor;
a floor cross beam, connected to lower longitudinal beams on outer sides in a vehicle-width-direction; and
a seat fixing portion, configured to fix a back seat,
wherein the seat fixing portion comprises:
a fixed seat surface, configured to fix the back seat formed on the floor behind the floor cross beam; and
a reinforcing member, forming a hollow portion with the fixed seat surface on an outside of the fixed seat surface, and the reinforcing member is connected to the floor cross beam.

2. The seat installation structure according to claim 1, wherein
the floor cross beam is provided between a front panel portion and a rear panel portion of the floor, where the rear panel portion is formed above the front panel portion,
the floor cross beam has a stepped portion between the front panel portion and the rear panel portion, and
the reinforcing member is provided above the stepped portion.

3. The seat installation structure according to claim 2, wherein
the stepped portion is entirely bent upward while extending from two ends toward a center.

4. The seat installation structure according to claim 1, wherein
the floor cross beam comprises an upper portion member and a lower portion member, and the upper portion member and the lower portion member form a closed cross-section,
the upper portion member comprises a front wall forming a front portion of the closed cross-section and an upper wall forming an upper portion of the closed cross-section,
the lower portion member comprises a rear wall forming a rear portion of the closed cross-section, a lower wall forming a lower side of the closed cross-section, and a rear wall extending portion extending upward from the rear wall to the rear portion of the closed cross-section, and
the reinforcing member is connected to the rear wall extending portion.

5. The seat installation structure according to claim 4, wherein
the reinforcing member comprises a flange, which is connected to the rear wall extending portion of the lower portion member, and the flange extends downward and comprises a protruded rib portion extending downward.

6. The seat installation structure according to claim 4, wherein
an end portion of an upper edge of the rear wall extending portion on an outer side in the vehicle-width-direction is provided with a bending portion extending toward the lower longitudinal beams and bent downward, and the reinforcing member is provided on an inner side of the bending portion in the vehicle-width-direction.
